(19) United States
(12) Patent Application Publication
(10) Pub. No.: US 2006/0222800 A1
(43) Pub. Date: Oct. 5, 2006

(54) Synthetic Cork with Tapered Edge by Heat Shrinking and Method Thereof

(75) Inventor: Brian Dolling, Adelaide, S.A. (AU)

Correspondence Address: KENYON & KENYON LLP, ONE BROADWAY, NEW YORK, NY, 10004, US

(73) Assignee: Nukorc Pty Ltd, Adelaide (AU)

(21) Appl. No.: 10/526,842

(22) PCT Filed: Aug. 28, 2003
(86) PCT No.: PCT/AU03/01100

§ 371 Date: Sep. 6, 2005

(30) Foreign Application Priority Data
Aug. 29, 2002 (AU) 20022951062

(51) Int. Cl. B32B 27/08; B65D 39/00; B32B 3/02

(52) U.S. Cl. 428/36.5; 428/35.7; 428/36.8; 428/66.3; 428/66.4

(57) ABSTRACT

Method of treating a synthetic closure or synthetic cork (24) made of expanded plastic material including heat shrinking the closure to effect an annular tapered portion or chamfered end (12, 14). The heat shrinking means includes heating members (42, 44) with heat contactable surfaces (46, 47) to contact at one or both end of the closure. The heating elements includes two elongated heating elements (42, 44) that allow the closure to roll over a heat contactable edge of each heating element to effect the heat shrinking to respective ends (16, 18) of the closure. The tapered or bevelled ends overcome the problem of a bulged end being formed when the closure is compressed for insertion into a neck of a bottle.

### TECHNICAL FIELD

This invention relates to closures made of expanded plastic material having a tapered end and a method of forming such closures.

### BACKGROUND ART

Wine bottles have traditionally been stoppered with corks made from natural cork material. However, this material can be subject to initial flaws, or deteriorate in use, resulting in contamination or spoilage of wine.

A common and well-known alternative to cork for sealing bottles, particularly wine, are “synthetic closures” or “synthetic corks”. These synthetic closures are made from expanded plastic material produced predominantly by either an injection molding or extrusion process.

An extruded synthetic closure, by virtue of employing a blade in the process of cutting the closures down to a predetermined length, tends to form an end that is substantially at an angle normal to the remaining body position of the closure.

A problem with such an arrangement is that when the closure is being compressed for insertion into the neck of a bottle, the insertable end bulges out from the body. This increases the diameter of the end with respect to the opening in the neck of the bottle and the remaining body portion of the closure. As the closure is forced into the neck, a bulged end is more likely to be tom away from the closure.

Further, as the end after compression of the closure remains at a greater diameter with the remaining body portion, once the closure is inserted into a bottle and withdrawn it then becomes difficult to reinsert the closure back into the bottle. If the closure with a bulged end is to be reinserted back into the bottle, more than a nominal force will need to be applied by a person in order to overcome the abutting surfaces of the bulge end against the neck of the bottle.

One way of overcoming the problems associated with either the bulge or normal angled corner between the end and the body of the closure is to grind back the corner to form a tapered end with respect to the body. By grinding the end of the closure before compression of the closure for insertion into the bottle, the removed grinded material compensates for any anticipated increase in the diameter that will occur at the end of the closure brought about by the compressive forces.

As the diameter of the end remains less than the remaining body position of the closure, abutment of the closure with the opening is limited or at least substantially avoided.

Further, as the end of the closure remains smaller than the remaining body portion, this tapering effect brought about by the grinding process, assists in reinserting the closure back into the bottle once withdrawn.

However, a problem with the grinding process is that as material is grinded away from the end to reduce the diameter to create the tapering effect, unattached specks remain on the grinded closure surface. When the closure is inserted into the bottle these specks may dislodge and contaminate the contents of the bottle.

It is, therefore, an object of the present invention to provide a closure having a tapered end and a method of forming such a closure without the need for grinding.

It is another object of the present invention to overcome, or at least substantially ameliorate some of the disadvantages and shortcomings of the closures discussed above.

Further secondary objects and advantages of the invention will become apparent on a reading of the complete description and claims hereafter.

### DISCLOSURE OF THE INVENTION

Accordingly, in one form of the invention there is provided a method of treating a closure made of expanded plastic material including heat shrinking the closure to effect a tapered end.

In a preferred form, the heat shrinking means includes a heating member adapted to contact an end of the closure. Preferably, the heating member is adapted to contact both ends of the closure.

An advantage of such an arrangement is that the heat shrinking of the closure to form a tapered end creates no separation or particles of specks from the closure, thereby avoiding any part of the closure contaminating the contents of the bottle.

An advantage of such an arrangement is that either end of the closure is effected for insertability into the neck of the bottle. Tapering at both ends of the closure enables versatility of the closure to be inserted at either end into the neck of the bottle

In a further preferred form, the heating member includes two elongated elements adapted to contact opposing ends of the closure. Preferably, the elements are such arranged to sufficiently support each end of the closure respectively so that when the closure is rolled along a contactable heating surface of each element, contact between the closure and element shrinks each end for a tapered effect.

Alternatively, the closure remains stationary with the heating elements rotably contacting the opposing ends to effect tapering of the ends.

Preferably, the elements contact only the ends of the closure.

Preferably, the elements are elongated.

An advantage of having two separate elements contacting only the ends of the closure enables the main body portion of the closure to be unexposed to any further heating in the expanded plastic state. As the body portion of the closure is not subjected to any heat during the heat shrinking process, printed indicia can be placed oh the main body portion of the closures before the closures are subjected to the heat shrinking of the ends to provide the tapered effect.

In a preferred form the tapered effect includes a beveled edge between the end and the remaining body portion of the closure.

In a further preferred form of this invention, although it need not necessarily be the only further form or indeed the broadest form, there is provided a closure made of expanded plastic material adapted for insertion into the neck of a bottle, said closure including a heat shrunk tapered end.

In a preferred form, the heat shrunk tapered end includes a beveled edge between the end and a remaining body portion.

### BRIEF DESCRIPTION OF THE DRAWINGS

For a better understanding of this invention, it will now be described in relation to a preferred embodiment, which shall be described with the assistance of drawings wherein:

FIG. 1 is a perspective view of a closure according to a preferred embodiment of the invention,

FIG. 2 is a perspective view of the closure being prepared for heat shrinking against the heating elements,

FIG. 3 is a perspective view of the closure passing across heat contactable surfaces of the heating elements,

FIG. 4 is a part exploded perspective view of one end of the closure contacting the heating elements for heat shrinking,

FIG. 5 is a perspective view of the heating elements and adjustability thereof for accommodating closures of differing diameters, and

FIG. 6 is a perspective view of the adjustment mechanism for aligning the angle of inclination of the heating elements with respect to the ends of the closure during heat shrinking.

### MODES FOR CARRYING OUT THE INVENTION

Referring to the drawings in detail, a closure 10 includes an annular tapered portion 12, 14 depending from a periphery at ends 16, 18 of the closure 10 thereof.

The annular tapered portions 12, 14 include a generally beveled or part spherical edge between an external surface 20, 22 at each end 16, 18 and a vertical cylindrical or tubular wall 24 disposed between the two opposed ends 16, 18.

The tubular wall 24 includes a main body 26 of the closure. The tubular wall 24 is integrally connected to the ends 16, 18.

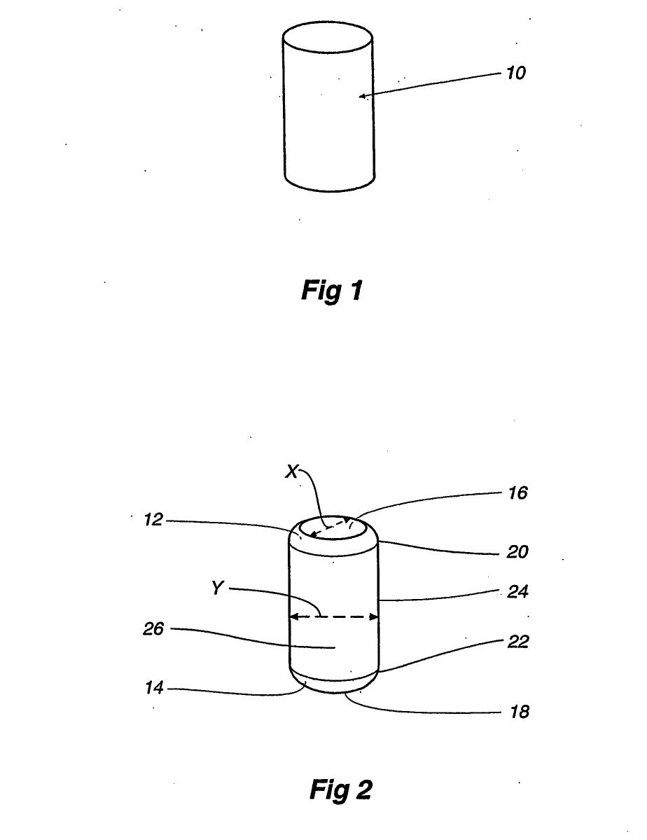

The diameter X (shown as a thin broken line in FIG. 1) for the closure 10 at the annual tapered portions 12, 14 is of a lesser length than the diameter Y (shown as a thicker broken line in FIG. 1) across the main body 26 surrounding the tubular wall 24.

During compression of the closure 10 before insertion into a neck of a bottle for sealing, the diameter Y of the tubular wall 24 surrounding the body 26 is reduced. Previously, this reduction of the diameter Y of the tubular wall 24 and body 26 resulted in the ends 16, 18 of the closure 10 bulging relative to the tubular wall 24 and the body 26. The bulge region or annular portion of the closure 10 that remained at the end of the tubular wall 24 made insertion of the closure 10 into the neck of the bottle more difficult due to abutment of the bulged ends with the collar of the neck of the bottle.

The problem being these ends of the closure 10 were subjected to a greater risk of damage, with the possibility of portions tearing away. Further, once the inserted closure was withdrawn, the compressed body 26 and tubular wall 24, though in part returning to an uncompressed state, maintained a diameter Y less than the ends. With the greater diameter at the ends of the closure 10, reinsertion of the closure 10 back into the bottle after withdrawal required more than just the nominal force of a user.

Referring to FIGS. 2-6, there is shown a preferred method of forming the annular tapered portion 12, 14 around the ends 16, 18 of the closure 10 do overcome the difficulties of the bulged ends.

It is, however, to be appreciated that a tapered presented edge between the tubular wall 24 and ends 16, 18 can be prepared in a variety of forms using a heat shrinking method. In the preferred form as shown in the FIG. 1, the edge is beveled.

However, any edge presenting a peripheral edge at an end with a smaller diameter to the main body 26 will suffice. For example, a uniform linear acute angled depression between the tubular wall 24 and the external surfaces 20, 22 at the ends 16, 18 provide for an end portion of a lesser diameter to the remaining body portion 26 of the closure 10.

In FIG. 2 the closure 10, already formed from a conventional extrusion process, is ready to undergo heat shrinking treatment at ends 16, 18.

What is significant to this invention is that the ends 16,18 of the closure 10 undergo a heat shrinking step so that the ends become beveled, chamfered and/or tapered with respect to the main body 26 tubular wall 24 of the closure 10.

The heat shrinking of the closure at ends 16,18 accomplishes the tapering effect, as shown by way of example in FIG. 1, as a beveled edge between the tubular wall 24 and the external surfaces 20, 22 at respective ends 16, 18.

The closure 10 is fed into a rectangular shaft 28 by a guide 30. Both shaft 28 and guide 30 are of a comparable size to the closure 10. The closure 10 passes down the shaft 28. As best shown in FIG. 2, the closure 10 falls through the shaft 28 and is interrupted by platform 32 where a piston rod 34 sets the closure into a circular movement motion along channel 36.

The channel 36 includes guides 38, 40 and heating elements 42, 44.

The top of the channel 36 also includes a conveyor belt 45 (not shown) to assist the closure 10 rolling travel along the channel 36.

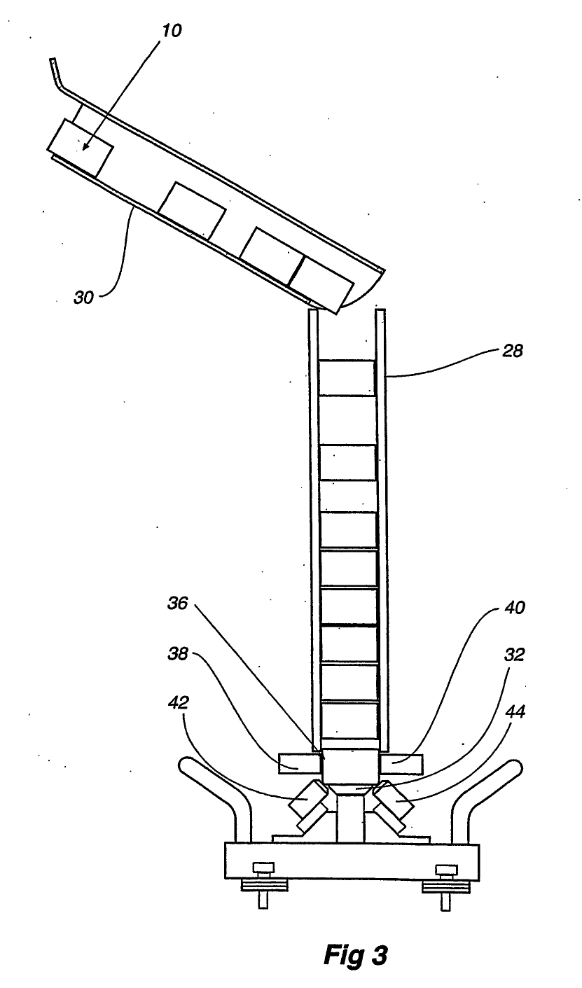

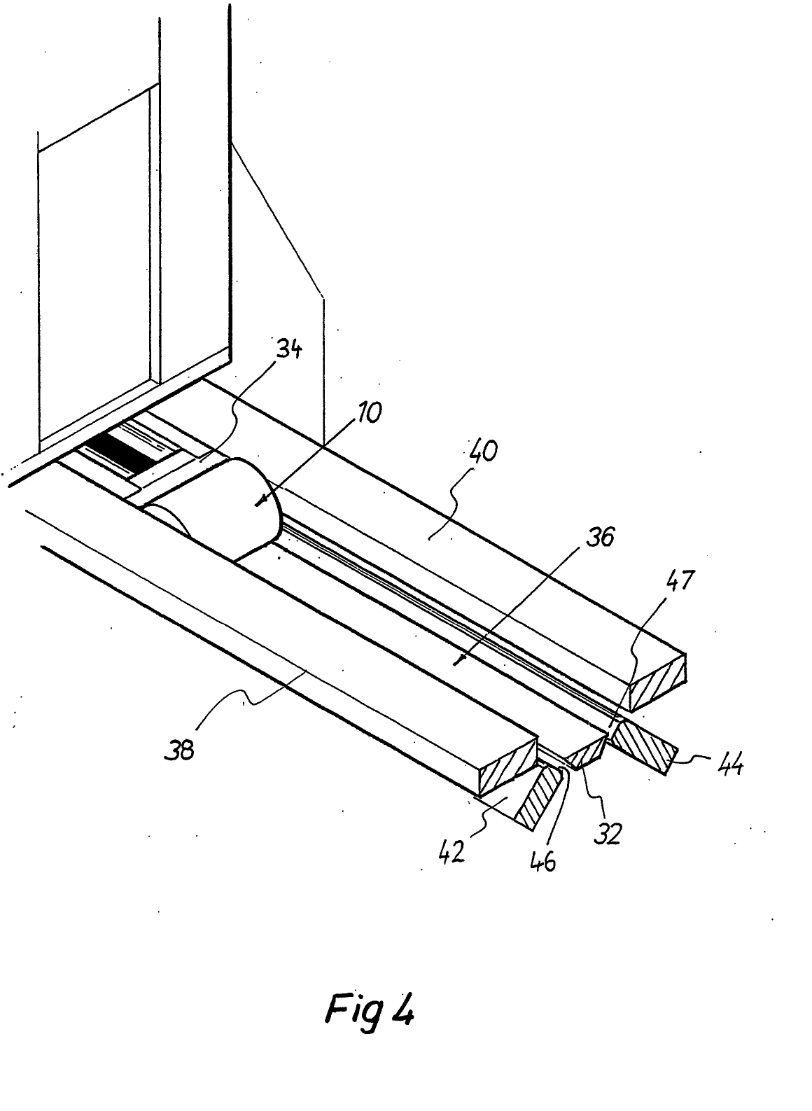

As best shown in FIGS. 3 and 4, the heating elements 42, 44 include heat contactable surfaces 46, 47 that engage the ends 16, 18 of the closure 10.

Alignment of the heating elements 42, 44 out of the horizontal plane of the channel 36 inclines the heat contactable surfaces 46, 47 such that limited contact is made between the heating element 44, 44 and the closure 10.

The inclined heating elements 42, 44 expose the heat contactable surfaces 46, 47 such that engagement is made with ends 16, 18 of the closure 10 and not with the remaining tubular wall 24.

As heat shrinking is only occurring at the ends 16, 18 of the closure 10 the tubular wall 24 remains unaffected from the heat shrinking process and thereby any printed material thereon the main body 26 is not subject to unnecessary detrimental heating that may deteriorate the printed material.

The contact of the heating elements 42, 44 with the ends 16, 18 heat shrinks the expanded plastic material of the extruded closure 10. The closure 10 engages with the heating elements 42, 44 as it rolls along the heat contactable surfaces 46, 47 effecting a tapered heat shrinking of the ends 16, 18 to form the annular tapered portions 12, 14 that depend inwards from the periphery at each end 16, 18.

It is, however, to be appreciated that it is only the preferred embodiment that includes the two heating elements 42, 44. Alternatively, for example a single heating element having just the one heat contactable surface may engage one end of the closure 10. That end of the closure 10 is then insertable into the neck of the bottle.

Further, the rolling action of the closure 10 with respect to the heat contactable surfaces of 46, 47 of the heating elements 42, 44 alternatively may be replaced by fixed contact between a stationary closure 10 and a moveable engageable heat contactable surface of the heating element or elements.

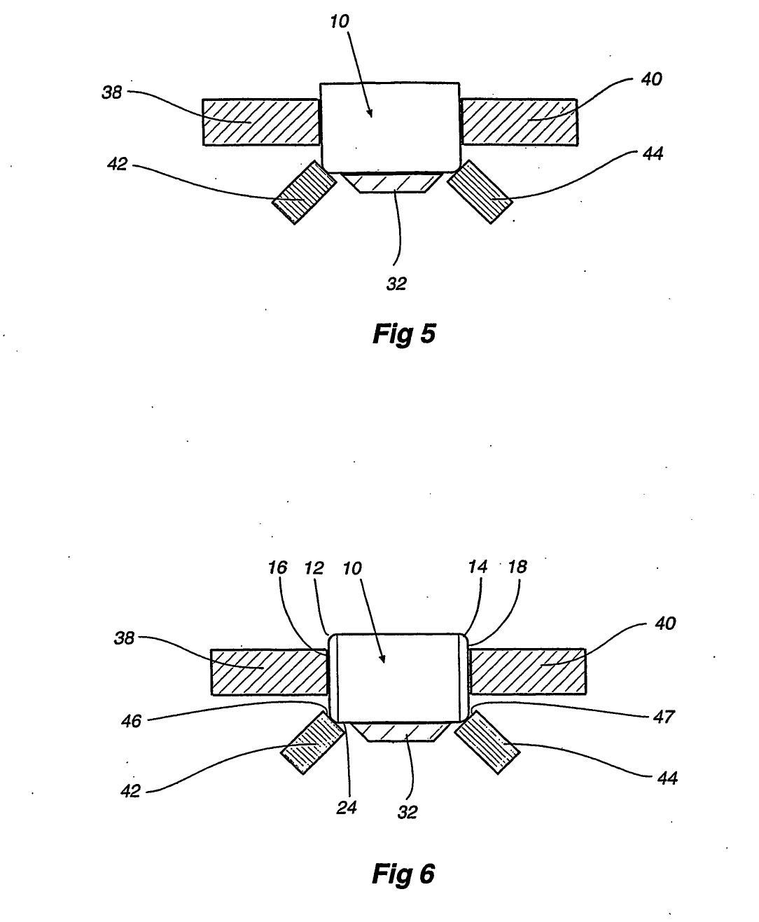

As shown in FIG. 5, the forming operation for effecting the heat shrunk tapered ends 16, 18 can be carried out on a closure 10 with a variety of diameters. This is accomplished by the adjusting of the distance between the inclined contactable surfaces 46, 47. The removal of support blocks 48, 50 lowers the heating elements 42, 44 relative to each other. This provides for a greater distance between the heat contactable surfaces 46, 47 presenting an adjustable area of contact that can accommodate a closure of varying diameters.

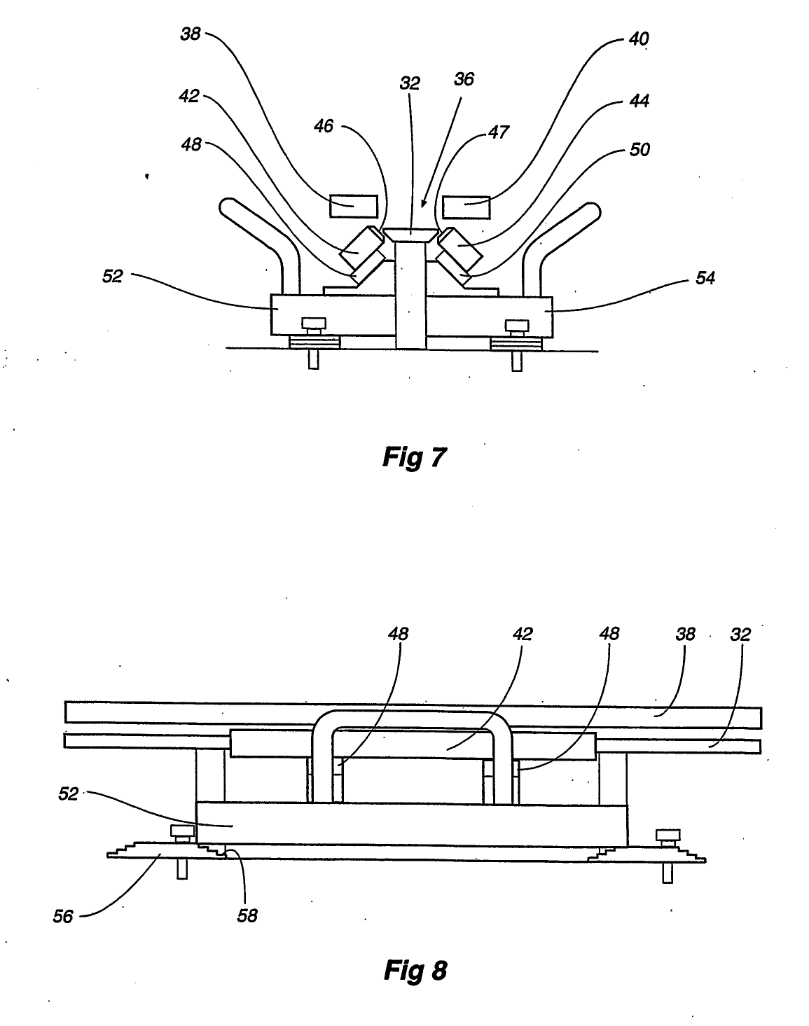

As best seen in FIG. 6, the forming operation for effecting the degree of tapering of the ends 16, 18 of the closure 10 can also be adjusted.

A base 52, 54 of each heating element 42, 44 makes contact with steps 56.

The steps 56 include rises 58 which act as abutments for the base 52, 54 to abut. The angle of inclination of the heating elements 42, 44 are adjusted by abutting base 52, 54 with respective rises 58 of the steps 56.

For example, as shown in FIG. 6, the angle of inclination of the heating elements 42, 44 with respect to the horizontal plane of the channel 36 are reduced as the heating elements are positioned higher up on steps 56. The broken lines indicate the changing α angle of the heating elements 42, 44 as moved up and down rises 58 of the steps 56 respectively.

It is to be appreciated by persons skilled in the art, that numerous variations and/or modifications may be made to the invention as shown in the specific embodiment, without departing from the spirit or scope of the invention as described.

The present embodiments are, therefore, to be considered in all respects as illustrative and not restrictive. Particularly, it can be appreciated that a variety of forms and shapes of the heating element may be made contactable with the closure in order to bring about heat shrinkage which effects a tapering or chamfering to the ends of the closure. It is the intention of this description to incorporate such arrangements.

1. A method of treating a closure made of expanded plastic material including heat shrinking the closure to effect a tapered end.

2. The method of claim 1 wherein the heat shrinking includes a heating member adapted to contact an end of the closure.

3. The method of claim 2 wherein the heating member is further adapted to contact both ends of the closure.

4. The method of claim 3 wherein the heating member includes two heating elements adapted to contact opposing ends of the closure.

5. The method of claim 4 wherein the heating elements are of an elongated form.

6. The method of claim 5 wherein the elongated heating element has at least one heat shrinking contactable edge so as to effect the tapered end to the closure.

7. The method of claim 6 wherein the heat shrinking contactable edge of each elongated heating element are symmetrically spaced with respect to the other elongated heating element, so as to be adapted to rollable contact the respective ends of the closure along the heat shrinking contactable edge to thereby effect a radial tapering of the said closure ends as said closure rolls along said contactable edges.

8. The method of claim 7 wherein the elongated heating elements are aligned such that each respective heat shrinking contactable edge contacts only the corresponding end of the closure.

9. The method of claim 8 further including spacing adjustment means for varying the symmetrical spacing between elongated heating elements so as to accommodate closures of differing dimensions.

10. The method of claim 9 wherein the adjustment means includes a series of supporting blocks for each elongated heating element, whereby the elongated heating element is adapted to rest on a predetermined number of blocks so as to define a predetermined spacing with the other elongated heating element to provide for the heat shrinking of the respective ends of a closure of a predetermined dimension.

11. The method of any one of claims 7 to 10 further including inclination adjustment means to vary an inclination of each elongated heating element so as to enable the heat shrinking contactable edges of said elongated heating elements to contact the respective ends of the closure at a predetermined aligned angle to effect a predetermined degree of tapering to said ends.

12. The method of claim 11 wherein the inclination adjustment means includes a stair case structure for each elongated heating element, such that each elongated heating element rests on a predetermined step of the stair case, so as to incline the respective heat contactable edge of the elongated element to provide a predetermined degree of tapering to the ends of the closure when being heat shrunk.

14. The method of claim 3 wherein the heating member includes opposed heat shrinking arms, each arm having a heat shrinking contact surface area adapted to engage a peripheral rim at the respective ends of the closure so as to shrink said rims to provide for a tapering or chamfering of each respective end.

15. A closure made of expanded plastic material treated by a method of any one of the preceding claims.

16. A method of treating a closure made of expanded plastic material as described in the specification with reference to and as illustrated by any one or more of the accompanying drawings.

17. A closure made of expanded plastic material treated according to the method of claim 16.
